(19) United States
(12) Patent Application Publication
(10) Pub. No.: US 2026/0067931 A1
(43) Pub. Date: Mar. 5, 2026

(54) SYSTEM AND METHOD FOR PERFORMING WIRELESS MEASUREMENT OPERATIONS

(71) Applicant: Samsung Electronics Co., Ltd., Suwon-si (KR)

(72) Inventors: Abhishek CHATURVEDI, Bengaluru (IN); Karthik Srinivasa Gopalan, Bengaluru (IN); Manasi Ekkundi, Bengaluru (IN)

(21) Appl. No.: 19/310,275

(22) Filed: Aug. 26, 2025

Related U.S. Application Data
(63) Continuation of application No. PCT/KR2025/012279, filed on Aug. 13, 2025.

(30) Foreign Application Priority Data
Aug. 27, 2024 (IN) 202441064562
Jul. 23, 2025 (IN) 202441064562

(51) Int. Cl. H04W 74/0816; H04W 8/22; H04W 24/10; H04W 60/04; H04W 74/00; H04W 84/12

(52) U.S. Cl. CPC H04W 74/0816; H04W 8/22; H04W 24/10; H04W 60/04; H04W 74/002; H04W 84/12

(57) ABSTRACT

A method for performing one or more measurement operations at a station (STA) device in a Wireless Local Area Network (WLAN) includes: transmitting, to an Access Point (AP), capability information indicating one or more parameters associated with Time Gap for Measurement (T_{GM}) supported by the STA device; receiving, from the AP, a time gap configuration from the AP in response to the transmitted capability information; and performing the one or more measurement operations based on the received time gap configuration, wherein the one or more measurement operations comprise at least one of one or more intra-frequency measurements, one or more inter-frequency measurements, one or more out-of-band beacon and pilot measurements, and one or more cross-technology measurements.

### CROSS-REFERENCE TO RELATED APPLICATIONS

This application is a continuation of International Application No. PCT/KR2025/012279 designating the United States, filed on Aug. 13, 2025, in the Korean Intellectual Property Office and claiming priority to Indian Provisional Patent Application No. 202441064562, filed on Aug. 27, 2024, and Indian Complete patent application No. 202441064562, filed on Jul. 23, 2025, in the Indian Patent Office, the disclosures of each of which are incorporated by reference herein in their entireties.

### BACKGROUND

### Field

The disclosure generally relates to wireless communication networks. For example, the present disclosure relates to a system and a method for performing one or more measurement operations at a station (STA) device in a Wireless Local Area Network (WLAN).

### Description of Related Art

Wireless Local Area Network (WLAN) radio measurements enable station devices (STAs) to be configured to observe and gather data on radio link performance and a radio environment. A STA device can choose to make measurements locally, request a measurement from another STA device, or request another STA device to make one or more measurements and return results. In addition, the radio measurement data is made available to a STA management and upper protocol layers, where the radio measurement data is further used for a range of applications, e.g., carrier sensing, channel measurements, Channel Status Information (CSI) feedback, location sensing, positioning, and mobility.

In an example, to address the mobility requirements of communication technologies, such as Voice over Internet Protocol (VOIP) and video streaming, the WLAN radio measurements, such as a channel load request or report and a neighbor request or report, can be used to collect transition information. The transition information drastically speeds up handoffs between Basic Service Sets (BSSs) within the same Extended Service Set (ESS). The STA device makes intelligent decisions about the most effective way to utilize an available spectrum, power, and bandwidth for communications using the transition information.

Additionally, from current Wireless-Fidelity (Wi-Fi) standards, some examples of the request or report-based measurements include beacon, frame, channel load, noise histogram, STA Statistics, Location Configuration Information (LCI), a neighbor report, link measurement, transmit stream or category measurement, the request-only mechanism, and the report-only mechanism. The request-only mechanism includes a measurement pause, and the report-only mechanism includes a measurement pilot.

The above-mentioned measurement mechanisms provide the capability for the STA device to manage and query the radio environment, and to make appropriate assessments about the health and efficiency of a wireless link and channel conditions. Such a capability helps in making WLAN smart and capable of making appropriate decisions for fast transition, for mesh connectivity, and managing the radio environment for all wireless devices.

Also, for measurement-related WLAN signalling and services, different techniques are used such as measurement pilot, link measurement, and radio measurement services. A measurement pilot frame provides a subset of the information provided in an Access Point's (AP's) beacon frame, which is smaller than a beacon frame and is transmitted more frequently as compared to the beacon frame. The purpose of the measurement pilot frame is to assist the STA device with scanning of channels.

In the link measurement, a request or report exchange provides measurements of the radio frequency (RF) characteristics of a STA-to-STA link. The link measurement indicates an instantaneous quality of the STA-to-STA link.

The radio measurement services provide the ability to request and report the WLAN radio measurements in supported channels. Additionally, the radio measurement services provide the ability to perform the WLAN radio measurements in the channels. Further, an interface for upper-layer applications to retrieve the WLAN radio measurements using Medium Access Control (MAC) Sublayer Management Entity (MLME) primitives, and information about neighbor APs are also provided by the radio measurement services.

Conventional Wi-Fi standards provide mechanisms for signalling based on demand request or report for various types of measurement information exchange between peer STA entities. However, for the rest of STA-Access Point (AP) associated duration, there is no standard support for assisted measurements, e.g., no long-term configuration support based on any predefined time or process to keep monitoring the channel and the neighbor APs (by STA) for taking self-optimized actions before loss of signal or service.

Further, Multi-Link Operations (MLO) have been defined in WiFi7 standards theoretically, such as a Multi-Link Single Radio (MLSR), an enhanced MLSR (eMLSR), a multi-link multi-radio (MLMR), and an enhanced MLMR (eMLMR). However, in practice, having multiple radio support from a hardware point of view is not cost and power-effective. Therefore, most of the 802.11 client devices continue to operate with a single main radio in either MLSR or eMLSR mode. Hence, given the radio limitations for cost-effectiveness, a standard long-term assisted measurement framework (for carrier sensing, channel measurements, and CSI feedback) needs to be defined.

Moreover, most of the WLAN measurements, outside the request or report based measurements, performed by the STA device currently are proprietary chipset vendor implementations and, hence, do not use the same mechanism across different 802.11 devices. This gives rise to the lack of a standard-defined long-term assisted measurement framework and related problems that require designing solutions and standards to achieve Wi-Fi8's Ultra High Reliability (UHR) in order to ensure comparable and uniform performance of each UHR (and beyond) device.

Also, the current WiFi8 standards present research contributions about mobility performance Key Performance Indicators (KPIs), which highlight problems associated with non-standard measurements resulting in issues of irregular ping pongs in mobility, thus strengthening the need for a standard-based AP-assisted, long-term measurement framework. Building upon the above identified gaps in a Wireless-Fidelity (Wi-Fi) measurement framework, an initial set of challenges is recognized relating to the absence of assisted timing and spectrum domain coordination for performing neighbor Access Point (AP) measurements. To address these challenges, a set of solutions is proposed that enables long-term assisted measurement operations to optimize such neighbor AP evaluations.

FIG. 1 is a block diagram 100 depicting a connectivity of the STA device 102 to a plurality of entities, in accordance with an existing technique. The STA device 102 includes a smartphone, a computing device, a tablet, a laptop, an Internet of Things (IoT) device, a smartwatch, an Augmented Reality (AR) headset, a Virtual Reality (VR) headset, Extended Reality (XR) headsets, an embedded system with display and input capabilities, or a non-AP STA device, and the like. An associated STA device 102 or non-AP Multi-Link Device (MLD) requires predefined time gaps to perform the WLAN radio measurements. The predefined time gaps are necessary when the STA device 102 or the non-AP MLD cannot measure the neighbor or target carrier frequency while simultaneously (e.g., intra-frequency measurements 110) transmitting or receiving on the AP 104, in durations when there is no on-demand measurement request or report performed by the AP 104, from a standards point of view (POV).

The associated STA device 102 or the non-AP MLD also requires the predefined time gaps to perform inter-frequency measurements 106, in durations when there is no on-demand measurement request or report performed by the AP 104, from the standards POV.

Also, the associated STA device 102 supports communications via other co-existence technology 108, such as Bluetooth, ultra-wideband, and Peer-to-Peer (P2P) wireless communication 112 running in parallel to a WLAN, for which the associated STA 102 requires the predefined time gaps to perform certain cross-chipset measurements or urgent co-existence operations or tasks.

FIG. 2 is a signal flow diagram illustrating a method 200 for communication of the STA device 102 with one or more APs 202a, 202b, 202c, and 202d to acquire neighbor AP(s) information for the purpose of AP evaluations, in accordance with an existing technique. The AP 202a corresponds to a serving AP 104.

At 210, the STA device 102 sends a neighbor request to the AP1 202a. The neighbor request is without any AP measurement information.

As shown in block 215, the AP1 202a includes information associated with all the potential neighbor APs 202b, 202c, and 202d belonging to same Service Set Identifier (SSID) or the ESS as per the neighbor request received from the STA device 102. At 220, the STA device 102 receives the neighbor report from the AP 202a. The neighbor report includes information associated with all the neighbor APs 202b-202d. However, a neighbor APs information is typically not optimized.

The neighbor APs information is not generated based on any measurement observed or reported by the STA device 102 through any type of self-measurement. As a result, the neighbor APs information includes redundant information associated with the neighbor APs 202b, 202c, and 202d lacking adequate signal strength or quality reachable by the STA device 102. Therefore, when the STA device 102 receives such neighbor APs information, the STA device 102 unnecessarily processes and evaluates 225 the information associated with the neighbor APs 202b, 202c, and 202d that are not actually useful for handover or roaming.

Therefore, using assisted measurements for the neighbor APs 202b, 202c, and 202d allows the STA device 102 to identify the neighbor APs 202b, 202c, and 202d based on actual observed measurement results, as shown in block 230. The STA device 102 can optimize the neighbor request and reporting procedures. The STA device 102 can also improve variations of such procedures, including Reduced Neighbor Report (RNR).

FIG. 3 is a graph 300 depicting STA characteristics plotted between frequency 302 and time 304, in accordance with an existing technique. The STA characteristics depict a sub-band change operation in a wide bandwidth BSS. Given the advancements in operating BSS bandwidth of the APs up to 320 MHz in 6 GHz spectrum, while still most of the residential and enterprise client STA devices operate on max 80 MHz bandwidth, the concept of Dynamic Sub-band Operations (DSO) and Non-Primary Channel Access (NPCA) is a high-priority focus item of the WiFi8 standards group. The DSO and NPCA essentially work upon the principle of migrating the STA device 102 to a different portion of the spectrum within the total operating bandwidth of the AP's BSS.

Conventional technologies suggest the use of non-High Throughput (HT) duplicate Physical Protocol Data Units (PPDUs) for transmitting beacons across the entire BSS bandwidth in 6 Gigahertz (GHz) APs. However, no similar options are available for 2.4 GHz or 5 GHz APs. Even for 6 GHz APs, such an approach leads to a straightforward wastage of valuable frequency resources and unnecessary additional transmission power consumption due to the duplication of the beacons. Accordingly, as an alternative solution to problems, the WLAN radio measurements by the STA device 102 require the predefined time gaps. The predefined time gaps allow the STA device 102 to perform measurements outside of currently assigned bandwidth.

The assigned bandwidth is typically configured by the AP 104 through Dynamic Sub-band Operation (DSO) or Non-Primary Channel Access (NPCA) procedures. This situation arises when the assigned bandwidth does not include the frequency resources used for Beacon transmissions or Measurement Pilots, which are generally associated with a primary channel of the AP. Additionally, at the same time, there is no on-demand measurement request or report being performed by the AP 104.

In view of the above, there is a need for a solution that overcomes the above deficiencies and addresses the issues such as the inability to perform reliable neighbor AP measurements during simultaneous transmissions, inconsistent inter-frequency scanning, and the absence of assisted measurement frameworks.

The drawbacks/difficulties or the disadvantages/limitations of conventional techniques explained in the background section are simply examples and the disclosure does limit its scope only to such limitations. One skilled in the art would understand that this disclosure and below mentioned description may also address other problems or overcome the other drawbacks/disadvantages of the conventional arts which are not explicitly captured above.

The description set forth in the background section should not be assumed to be prior art merely because it is set forth in the background section. The background section may describe aspects or embodiments of the present disclosure.

### SUMMARY

According to an example embodiment of the present disclosure, a method for performing one or more measurement operations at a station (STA) device in a Wireless Local Area Network (WLAN) is disclosed. The method includes: transmitting, to an Access Point (AP), capability information indicating one or more parameters associated with Time Gap for Measurement (T_{GM}) supported by the STA device; receiving, from the AP, a time gap configuration in response to the transmitted capability information; and performing the one or more measurement operations based on the received time gap configuration, wherein the one or more measurement operations comprise at least one of one or more intra-frequency measurements, one or more inter-frequency measurements, one or more out-of-band beacon and pilot measurements, and one or more cross-technology measurements.

According to an example embodiment of the present disclosure, a method for performing one or more neighbor measurements at a station (STA) device in a Wireless Local Area Network (WLAN) is disclosed. The method includes: performing one or more measurement operations based on a received time gap configuration, wherein the one or more measurement operations comprise at least one of one or more intra-frequency measurements, one or more inter-frequency measurements, one or more out-of-band beacon and pilot measurements, and one or more cross-technology measurements; based on performing the one or more measurement operations, detecting neighbor Access Points (APs) or one or more frequencies; determining one or more AP identifiers for one or more detected neighbor Access Points (APs) or the one or more frequencies based on a Received Signal Strength Indicator (RSSI) exceeding a specified threshold; transmitting a neighbor report request message to the AP, wherein the neighbor report request message comprises the one or more determined AP identifiers; receiving a neighbor report message from the AP, wherein the neighbor report message comprises information corresponding to the one or more AP identifiers; and performing the one or more neighbor measurements and evaluation based on the received neighbor report message.

According to an example embodiment of the present disclosure, a method for transmitting a time gap configuration by an access point (AP) in a Wireless Local Area Network (WLAN) is disclosed. The method includes: receiving capability information from a station (STA) device, the capability information indicating one or more parameters associated with Time Gap for Measurement (T_{GM}) supported by the STA device; determining the time gap configuration for the STA device, based on at least one of the capability information of the STA device, radio frequency tuning information associated with the STA device, or transmission scheduling information; and transmitting the time gap configuration to the associated STA device.

According to an example embodiment of the present disclosure, a system for performing one or more measurement operations at a station (STA) device in a Wireless Local Area Network (WLAN) is disclosed. The system includes: a memory and at least one processor, comprising processing circuitry, coupled with the memory, wherein at least one processor, individually and/or collectively, is configured to cause the system to: transmit, to an Access Point (AP), capability information indicating one or more parameters associated with Time Gap for Measurement (T_{GM}) supported by the STA device; receive, from the AP, a time gap configuration in response to the transmitted capability information; and perform the one or more measurement operations based on the received time gap configuration, wherein the one or more measurement operations comprise at least one of one or more intra-frequency measurements, one or more inter-frequency measurements, one or more out-of-band beacon and pilot measurements, and one or more cross-technology measurements.

According to an example embodiment of the present disclosure, a system for performing one or more neighbor measurements at a station (STA) device in a Wireless Local Area Network (WLAN) is disclosed. The system includes: a memory and at least one processor, comprising processing circuitry, coupled with the memory, wherein at least one processor, individually and/or collectively, is configured to cause the system to: perform one or more measurement operations based on a received time gap configuration, wherein the one or more measurement operations comprise at least one of one or more intra-frequency measurements, one or more inter-frequency measurements, one or more out-of-band beacon and pilot measurements, and one or more cross-technology measurements; based on performing the one or more measurement operations, detect neighbor Access Points (APs) or one or more frequencies; determine one or more identifiers of the detected neighbor Access Points (APs) or the one or more frequencies based on a Received Signal Strength Indicator (RSSI) exceeding a specified threshold; transmit a neighbor report request message to the AP, the neighbor report request message comprising the one or more AP identifiers; receive a neighbor report message from the AP, the neighbor report message comprising information corresponding to the one or more AP identifiers; and perform the one or more neighbor measurements and evaluation based on the received neighbor report message.

According to an example embodiment of the present disclosure, a system for transmitting a time gap configuration by an access point (AP) in a Wireless Local Area Network (WLAN) is disclosed. The system includes: a memory and at least one processor, comprising processing circuitry, coupled with the memory, wherein at least one processor, individually and/or collectively, is configured to cause the system to: receive capability information from a station (STA) device. The capability information indicating one or more parameters associated with Time Gap for Measurement (T_{GM}) supported by the STA device; determine the time gap configuration for the STA device, based on at least one of the capability information of the STA device, radio frequency tuning information associated with the STA device, or transmission scheduling information; and transmit the time gap configuration to the associated STA device.

To further clarify various advantages and features of the present disclosure, a more detailed description will be rendered by reference to various example embodiments thereof, which are illustrated in the appended drawings. It is appreciated that these drawings depict example embodiments and are therefore not to be considered limiting of its scope. The disclosure will be described and explained with additional specificity and detail with the accompanying drawings.

### BRIEF DESCRIPTION OF THE DRAWINGS

The above other aspects, features, and advantages of certain embodiments of the present disclosure will be more apparent from the following detailed description taken in conjunction with the accompanying drawings in which like characters represent like parts throughout the drawings.

FIG. 1 is a block diagram depicting a connectivity of a Station (STA) device to a plurality of entities.

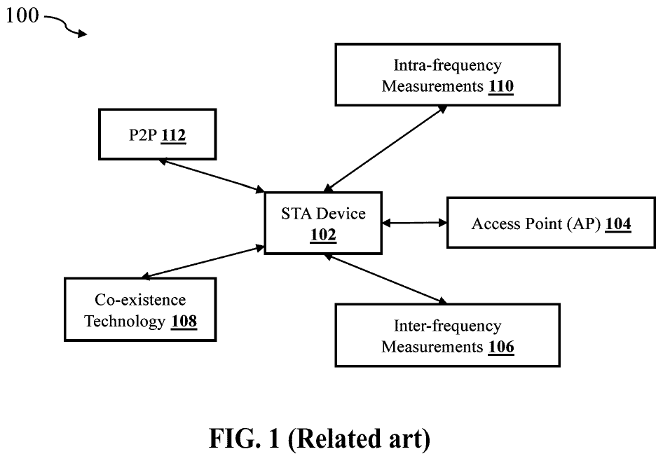

FIG. 2 is a signal flow diagram depicting a method for communication of the STA device with one or more Access Points (APs) to acquire neighbor AP(s) information for the purpose of AP evaluations.

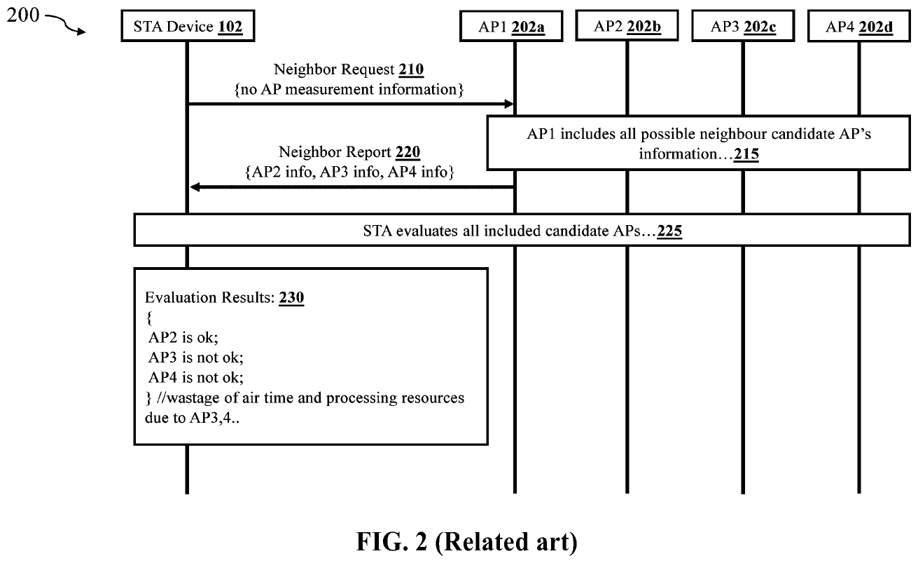

FIG. 3 is a graph depicting STA characteristics plotted between frequency and time.

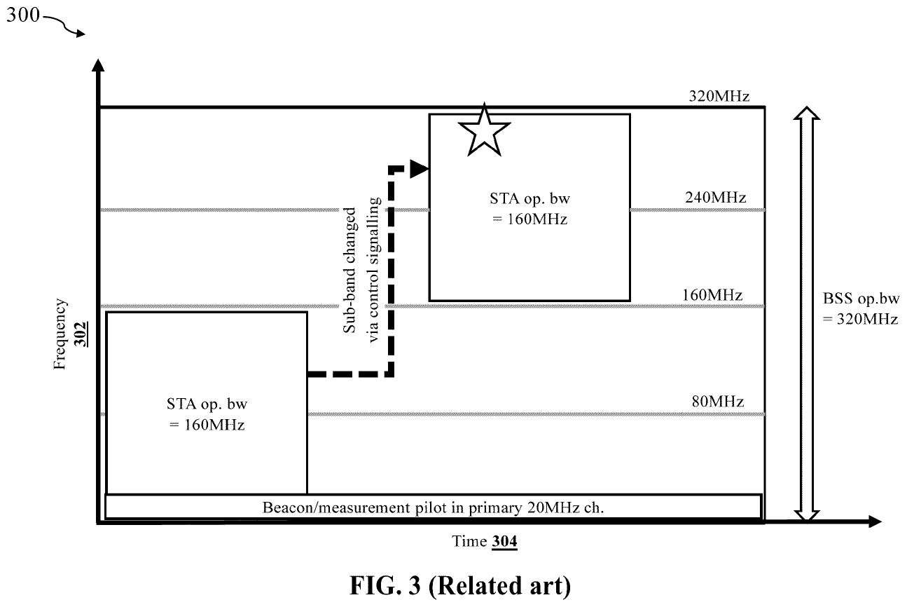

FIG. 4 is a block diagram illustrating an environment for a system for performing one or more measurement operations at a station (STA) device in a Wireless Local Area Network (WLAN), according to various embodiments.

FIG. 5 is a flowchart illustrating an example method for performing the one or more measurement operations at the STA device in the WLAN, according to various embodiments.

FIG. 6 is a flowchart illustrating an example method for performing the one or more neighbor measurements at the STA device in the WLAN, according to various embodiments.

FIG. 7 is a flowchart illustrating an example method for transmitting a time gap configuration by an Access Point (AP) in the WLAN, according to various embodiments.

FIG. 8 is a flowchart illustrating an example method for optimizing a neighbor report request message, according to various embodiments.

FIG. 9 is a block diagram illustrating an example transmission of capability information of the STA device to the AP, according to various embodiments.

FIG. 10 is a block diagram illustrating an example optimal value of the time gap configuration, (T_{GM}_value) by the AP, according to various embodiments.

FIG. 11 is a signal flow diagram illustrating an example method for performing one or more intra-frequency measurements, according to various embodiments.

FIG. 12 is a signal flow diagram illustrating an example method for performing one or more inter-frequency measurements, according to various embodiments.

FIG. 13 is a signal flow diagram illustrating an example method for performing the one or more neighbor measurements at the STA device, according to various embodiments.

FIG. 14 is a diagram illustrating an example use case illustrating an example method for performing one or more out-of-band beacons and pilot measurements, according to various embodiments.

FIG. 15 is a diagram illustrating one or more cross-technology measurements performed by the STA device, according to various embodiments.

FIG. 16 is a flowchart illustrating an example method for transmitting a report message based on the one or more measurement operations, according to various embodiments.

FIG. 17 is a block diagram illustrating an example configuration of an STA device, according to various embodiments.

FIG. 18 is a block diagram illustrating an example configuration of an AP, according to various embodiments.

Further, skilled artisans will appreciate that elements in the drawings are illustrated for simplicity and may not have necessarily been drawn to scale.

Furthermore, in terms of the construction of the device, one or more components of the device may have been represented in the drawings by conventional symbols, and the drawings may show those specific details that are pertinent to understanding the various embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various example embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.” For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C.

Reference is made herein to some “embodiments.” It should be understood that an embodiment is an example of a possible implementation of any features and/or elements of the present disclosure. Various embodiments have been described for the purpose of explaining one or more of the potential ways in which the specific features and/or elements of the disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in greater detail with reference to the accompanying drawings.

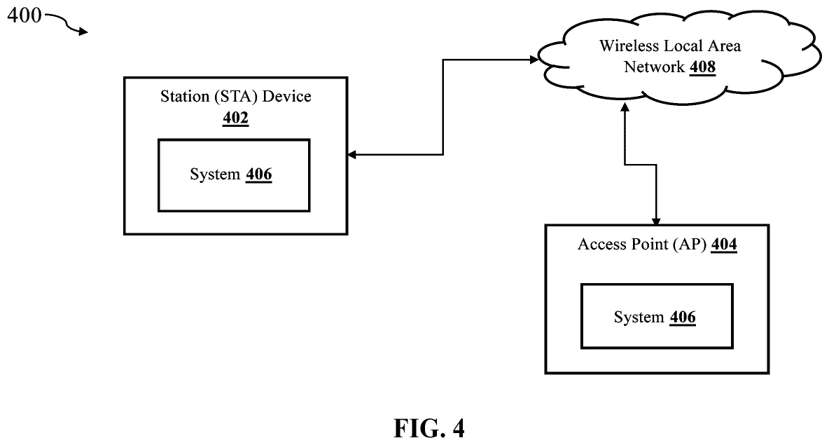

FIG. 4 is a diagram illustrating an example environment 400 for implementation of a system 406 for performing one or more measurement operations at a station (STA) device 402 in a Wireless Local Area Network (WLAN), according to various embodiments. The environment 400 may include the STA device 402, an Access Point (AP) 404, and the WLAN 408. The WLAN 408 may correspond to a wireless communication network that enables the AP 404 and the STA device 402 to communicate with each other using radio frequency transmissions. The WLAN 408 may typically provide local network connectivity within a limited area, such as an office, home, enterprise, or campus environment.

It should be understood that the environment 400 described herein may include a plurality of STA devices and one or more APs. The examples and figures may illustrate a single STA device 402 communicating with a single AP 404 for simplicity of explanation. However, the plurality of STA devices may simultaneously interact with the one or more APs within the WLAN 408.

The STA device 402 may include, but is not limited to, a smartphone, a computing device, a tablet, a laptop, an Internet of Things (IoT) device, a smartwatch, an Augmented Reality (AR) headset, a Virtual Reality (VR) headset, Extended Reality (XR) headsets, an embedded system with display and input capabilities, or a non-AP STA device, and the like.

The AP 404 may be a central coordinator for the STA device 402 in the WLAN 408. In an embodiment, the AP 404 may be a network device that provides wireless connectivity and management services to the STA device 402.

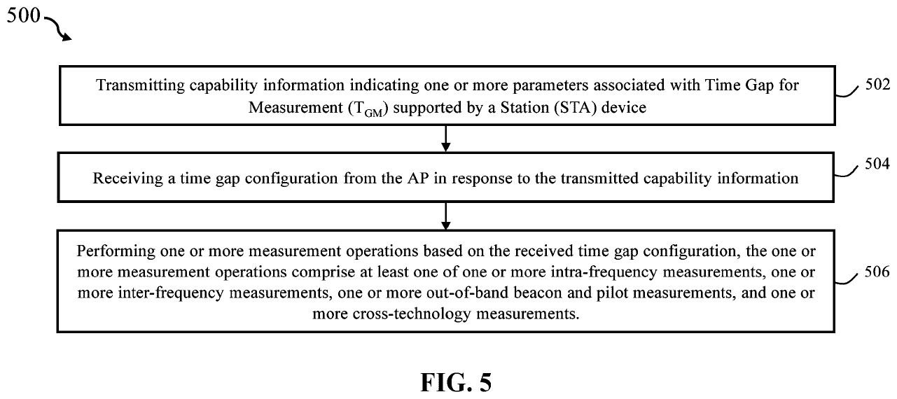

In an embodiment, the STA device 402 may include the system 406 configured to perform the one or more measurement operations. The one or more measurement operations comprise at least one of one or more intra-frequency measurements, one or more inter-frequency measurements, one or more out-of-band beacon and pilot measurements, and one or more cross-technology measurements at the STA device 402. In an embodiment, the system 406 may be externally connected to the STA device 402. In an embodiment, few components of the system 406 may be externally connected to the STA device 402, and rest of the components of the system 406 may be internally implemented within the STA device 402. The STA device 402 is described in greater detail below with reference to FIGS. 5, 6 and 17.

In an embodiment, the system 406 may be configured to perform one or more neighbor measurements at the STA device 402 in the WLAN 408. The one or more neighbor measurements may include, but are not limited to, determining signal strength, channel conditions, link quality, or other radio parameters associated with one or more neighbor APs. The one or more neighbor APs may be operated within the one or more intra-frequency measurements or the one or more inter-frequency measurements of the STA device 402.

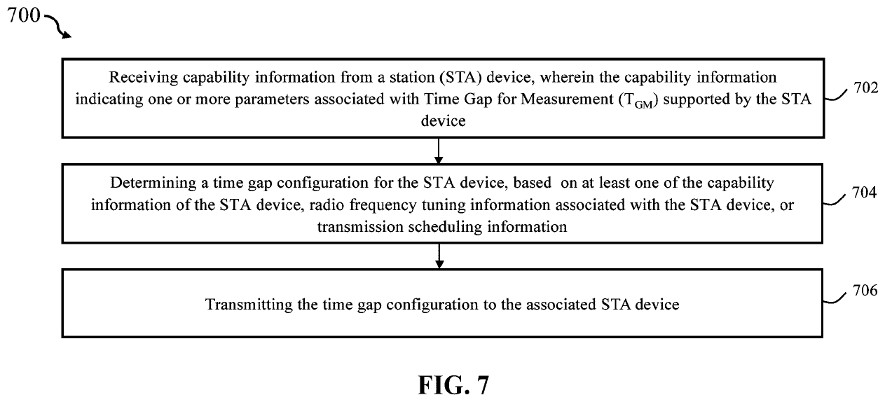

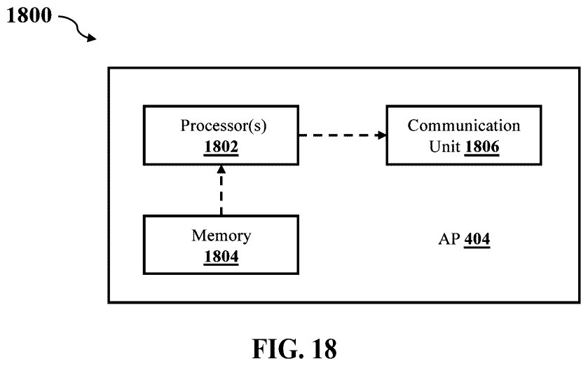

In an embodiment, the AP 404 may include the system 406. In an embodiment, the system 406 may be externally connected to the AP 404. In an embodiment, few components of the system 406 may be externally connected to the AP 404, and rest of the components of the system 406 may be internally implemented within the AP 404. The AP 404 may be configured to transmit a time gap configuration to the STA device 402. The time gap configuration may include a plurality of measurement configuration parameters corresponding to a plurality of radio frequency chains. The plurality of measurement configuration parameters may include, but are not limited to, a time gap value, gap offset, gap length, and gap periodicity, a validity parameter, an event trigger. The plurality of radio frequency chains may include, but are not limited to, a primary serving channel, a neighbor or target channel, different frequency band, and the like. The AP 404 is described in greater detail below with reference to FIGS. 7 and 18.

FIG. 5 is a flowchart illustrating an example method 500 for performing the one or more measurement operations at the STA device 402 in the WLAN 108, according to various embodiments. The method 500 may be a computer-implemented method executed, for example, by one or more processors and module(s).

At 502, the method 500 may include transmitting, to the AP 404, capability information indicating one or more parameters associated with Time Gap for Measurement (T_{GM}) supported by the STA device 402.

In an embodiment, the capability information may include a T_{GM} support bit and a technology parameter. The T_{GM} support bit may indicate support for the time gap configuration. The technology parameter may indicate support for different types of technologies and one or more timing parameters per radio frequency (RF) band associated with each of the different types of technologies.

At 504, the method 500 may include receiving, from the AP 404, the time gap configuration in response to the transmitted capability information.

At 506, the method 500 may include performing the one or more measurement operations based on the received time gap configuration. The one or more measurement operations may include at least one of the one or more intra-frequency measurements, the one or more inter-frequency measurements, the one or more out-of-band beacon and pilot measurements, and the one or more cross-technology measurements associated with one or more co-existing technology operations, by tuning the radio frequency of the STA device 402 during time gap defined by the time gap configuration. The one or more cross-technology measurements may include, but are not limited to, measuring signal quality, interference, or coexistence performance for, e.g., Bluetooth, Ultra-Wideband (UWB), Peer-to-Peer (P2P), or other co-located radio technologies while the STA device 402 remains associated with the AP 404.

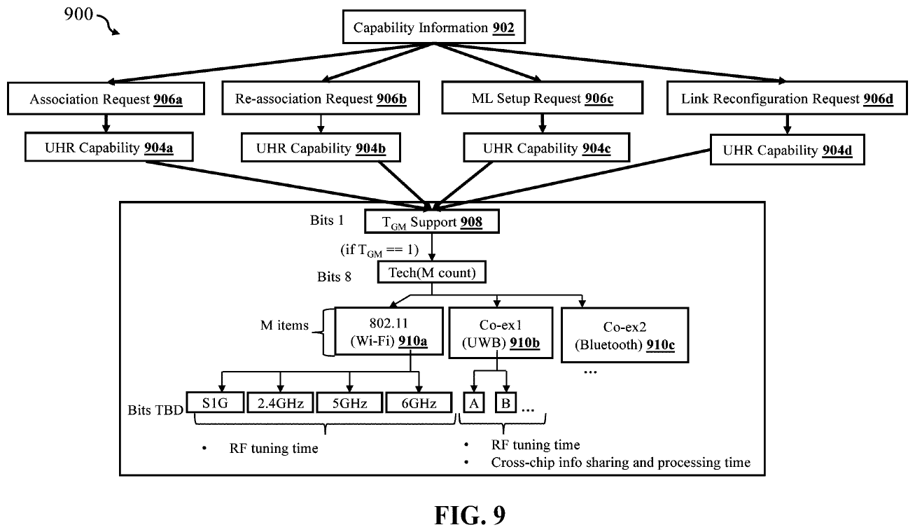

In an embodiment, for transmitting the capability information, the method 500 may include transmitting the capability information in one of an association request, a re-association request, a multi-link setup request, or a link reconfiguration request message. The capability information is described in greater detail below with reference to FIG. 9.

In an embodiment, the method 500 may include performing, based on the received time gap configuration, at least one or more of the intra-frequency measurements and the inter-frequency measurements on one or more neighboring APs.

The method 500 may include performing, based on the received time gap configuration, the one or more cross-technology measurements associated with one or more co-existing technology operations, by tuning the radio frequency of the STA device 402 during time gap defined by the time gap configuration. The one or more cross-technology measurements may include, but are not limited to, measuring signal quality, interference, or coexistence performance for, e.g., Bluetooth, Ultra-Wideband (UWB), Peer-to-Peer (P2P), or other co-located radio technologies while the STA device 402 remains associated with the AP 404.

In an embodiment, in response to receiving a WLAN measurement request from the AP 404, the method 500 may include determining whether a corresponding measurement result is already stored and remains valid based on the validity parameter associated with the time gap configuration corresponding to the WLAN measurement request. The WLAN measurement request may instruct the STA device 402 to perform the one or more measurement operations and to report the corresponding measurement result to the AP 404.

In response to determining that the stored corresponding measurement result is valid, the method 500 may include transmitting, a report message to the AP 404. The report message may include the stored corresponding measurement result.

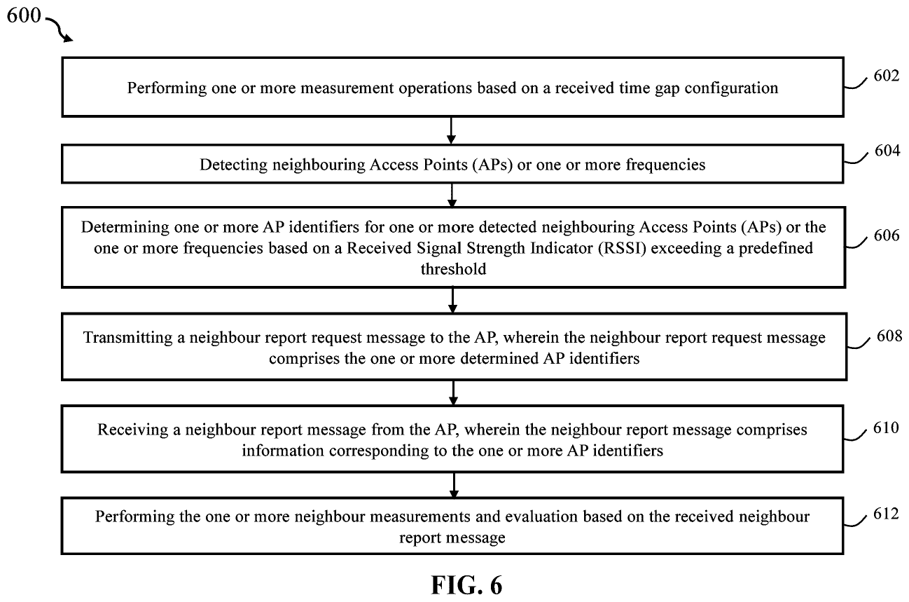

FIG. 6 is a flowchart illustrating an example method 600 for performing the one or more neighbor measurements at the STA device 402 in the WLAN 408, according to various embodiments. The method 600 may be a computer-implemented method executed, for example, by one or more processors and module(s).

At 602, the method 600 may include performing the one or more measurement operations based on the received time gap configuration. The one or more measurement operations may include, but are not limited to, the one or more intra-frequency measurements and the one or more inter-frequency measurements.

At 604, upon performing the one or more measurement operations, the method 600 may include detecting the one or more neighbor APs or one or more frequencies.

In an embodiment, the STA device 402 may be configured to measure radio signals within the WLAN 408 to identify the one or more neighbor APs that are operating within a same Extended Service Set (ESS) or in nearby frequency bands.

At 606, the method 600 may include determining one or more AP identifiers for the one or more detected neighbor APs or the one or more frequencies based on a Received Signal Strength Indicator (RSSI) of the AP 402 exceeding a predefined threshold.

At 608, the method 600 may include transmitting a neighbor report request message to the AP 404. The neighbor report request message may include the one or more determined AP identifiers. The one or more determined AP identifiers may include a Basic Service Set Identifier (BSSID), a Service Set Identifier (SSID), and the like.

At 610, the method 600 may include receiving a neighbor report message from the AP 404. The neighbor report message may include information corresponding to the one or more AP identifiers.

At 612, the method 600 may include performing the one or more neighbor measurements and evaluation of the AP 404 based on the received neighbor report message.

FIG. 7 is a flowchart illustrating an example method 700 for transmitting the time gap configuration by the AP 404 in the WLAN 408, according to various embodiments. The method 700 may be a computer-implemented method executed, for example, by the one or more processors and the module(s).

At 702, the method 700 may include receiving the capability information from the STA device 402. The capability information may indicate the one or more parameters associated with the T_{GM} supported by the STA device 402. The one or more parameters may include, but are not limited to, a T_{GM} support bit, the technology parameter, and the like.

At 704, the method 700 may include determining the time gap configuration for the STA device 402, based on at least one of the capability information of the STA device 402, radio frequency tuning information associated with the STA device 402, or transmission scheduling information.

The time gap configuration may include the plurality of measurement configuration parameters corresponding to the plurality of radio frequency chains.

At 706, the method 700 may include transmitting the time gap configuration to the associated STA device 402.

The time gap configuration may include the event trigger indicating a condition under which the STA device 402 is to perform the one or more measurement operations.

In an embodiment, for determining the time gap configuration, the method 700 may include determining the time gap configuration by configuring at least one of a single optimal value applicable across a plurality of frequencies, a plurality of values per a radio frequency chain, or a frequency band based on a frequency-specific measurement configuration indicator.

In an embodiment, for transmitting the time gap configuration, the method 700 may include transmitting the time gap configuration in one of an association response message, a re-association response message, a multi-link setup response message, or a link re-configuration response message.

Further, the method 700 may include determining a duration parameter associated with the time gap configuration. The duration parameter may be determined based on one or more of a transmission opportunity (TXOP) interruption duration, an inter frame spacing interval, an Enhanced Distributed Channel Access (EDCA) backoff duration, or an Uplink Orthogonal-Frequency-Division-Multiplexing Random Access (U-OFDMA) backoff duration. The TXOP may be a defined time interval during which the STA device 402 or the AP 404 has right to transmit frames without contention.

The EDCA backoff duration may provide differentiated channel access using contention windows and random backoff times. The EDCA backoff duration may be the period during which the STA device 402 defers transmission while counting down a random timer. The U-OFDMA may allow users to share an uplink channel simultaneously using sub-carriers. A U-OFDMA backoff duration may be the time a STA device 402 waits before transmitting during a random access phase.

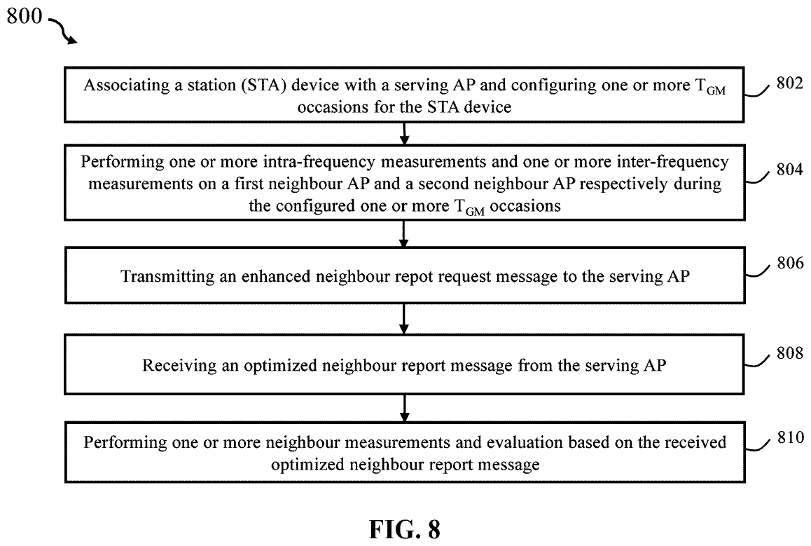

FIG. 8 is a flowchart illustrating an example method 800 for optimizing the neighbor report request message, according to various embodiments.

At 802, the method 800 may include associating the STA device 402 with a serving AP and configuring one or more Tom occasions for the STA device 402. In an embodiment, the configuration of the one or more Tom occasions may be based on an Ultra High Reliability (UHR) capability negotiation between the STA device 402 and the serving AP.

At 804, the method 800 may include performing, by the STA device 402, the one or more intra-frequency measurements and the one or more inter-frequency measurements on a first neighbor AP and a second neighbor AP, respectively, during the configured one or more T_{GM} occasions.

At 806, the method 800 may include transmitting, by the STA device 402, the enhanced neighbor report request message to the serving AP. In an example embodiment, the enhanced neighbor report request message may include a subset of measured neighbor AP identifiers or frequencies that the STA device 402 has measured with signal strength (RSSI) values above a predefined threshold. The predefined threshold may either be self-defined or configured by the serving AP. The STA device 402 may include the subset in the neighbor report request message to get a list of neighbor APs information for evaluation of potential target candidates, especially during mobility scenarios.

At 808, the method 800 may include receiving, at the STA device 402, an optimized neighbor report message from the serving AP. The optimized neighbor report message may only include information corresponding to the subset of the measured neighbor AP identifiers/frequencies included in the neighbor report request message. With the inclusion of the subset in the neighbor report request message, instead of including information for all possible candidate neighbor APs, the serving AP is only required to include the information corresponding to the subset of APs (e.g., the included ones by the STA device 402) in the optimized neighbor report message to the STA device 402.

At 810, the method 800 may include performing, by the STA device 402, the one or more neighbor measurements and evaluation based on the received optimized neighbor report message.

FIG. 9 is a diagram 900 illustrating example transmission of the capability information 902 of the STA device 402 to the AP 404, according to various embodiments.

As shown in FIG. 9, if a standard feature radio measurement (e.g., dot11RadioMeasurementActivated) is valid, a UHR STA device or a non-AP Multi-Link Device (MLD) may first declare the T_{GM} support bit 908 for the time gap configuration.

In an embodiment, the UHR capability field 904a or 904b of either the association request message 906a or the re-association request message 906b respectively may include the capability information 902. Further, the UHR capability field 904c or 904d of either the multi-link setup request message 906c or the link re-configuration request message 906d respectively may include the updated capability information.

In an embodiment, the capability information 902 may include the T_{GM} support bit 908 and the technology parameter. The T_{GM} support bit 902 may indicate the support for the time gap configuration. For example, if the T_{GM} support bit is set to 1, then a following bitmap of 1-octet (8-bits) field may be included in capability information 902 to indicate the different types of technologies from an RF support point of view. The RF support point of view may include a co-existence of the STA device 402 or the non-AP MLD, such as Wireless-Fidelity (Wi-Fi) 910a, Ultra-Wide Band (UWB) 910b, and Bluetooth 910c. Corresponding to each technology supported, there may be a bitmap of RF chains or frequencies supported, with further associated information per radio frequency (RF) chain per technology.

The technology parameter may indicate the support for the different types of technologies and the one or more timing parameters per RF band associated with each of the different types of technologies. Each of the different types of technologies may indicate the minimum time gap required for measuring each of the corresponding supported technologies.

In an embodiment, the information per RF chain or frequency per technology may include the minimum time gap. The minimum time gap may include, but is not limited to, time to tune RF to that particular frequency and back, time for measuring that particular frequency, the TXOP duration, the SP duration, and, in case of co-existence technologies 910b and 910c, time taken for cross-chipset information sharing and processing, and the like.

In an embodiment, the time gap configuration may include a gap offset, a gap length, a gap periodicity, an event trigger, and a validity parameter associated with a T_{GM}_value time duration. The gap offset may be applied before starting the T_{GM}_value time duration. The gap length may be the length of the T_{GM} value time duration. The gap periodicity may be a periodicity of applying the T_{GM}_value time duration.

The event trigger may be an optional criterion configured by the AP 404. When an event trigger condition is met, the AP 404 may dynamically initiate an instant T_{GM}_value gap for the one or more measurement operations.

For example, a pre-emption event may occur when the STA device 402 is in an active data session, but the session is suspended due to another low-latency traffic stream. In the pre-emption event, the time gap configuration may be used for performing the one or more measurement operations.

Similarly, if the RSSI of the AP 404 as measured by the STA device 402 falls below a predefined threshold, the STA device 402 may apply a measurement gap for performing neighbor AP measurements. The validity parameter may ensure that the one or more measurement operations performed within a certain time gap are valid until a new or fresh measurement is required for the same frequency or frequencies.

The technology parameter may indicate support for different types of technologies and one or more timing parameters per radio frequency (RF) band associated with each of the different types of technologies. The different types of technologies may include, but are not limited to, Bluetooth, Ultra-Wideband (UWB), Peer-to-Peer (P2P), or other co-located radio technologies. Each of the different types of technologies may specify at least a minimum time gap required for performing the one or more measurement operations for the corresponding technology. The minimum time gap may include, but is not limited to, time to tune RF to a predefined frequency and back, time for measuring that particular frequency, transmission opportunity (TXOP) duration, Service Period (SP) duration, and in case of co-existing technologies, time taken for cross-chipset information sharing and processing, and the like.

In an embodiment, the UHR capability field of either the association request or the re-association request as well may include the capability information. Later, the UHR capability field of either the multi-link setup request or the link reconfiguration request message may include updated capability information.

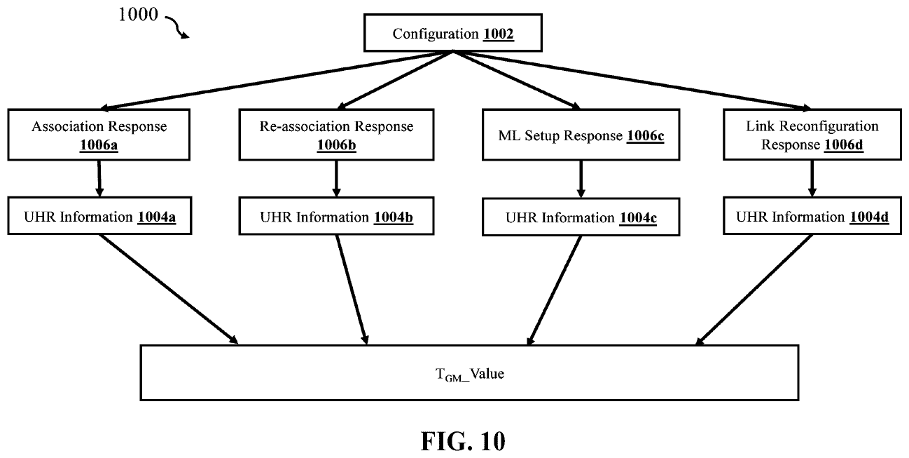

FIG. 10 is a diagram 1000 illustrating an example optimal value of the time gap configuration (T_{GM}_value) by the AP 404, according to various embodiments.

As shown in FIG. 10, if the standard feature radio measurement (e.g., the dot11RadioMeasurementActivated) is valid, based on the capability information 902 as shared by the STA device 402 in the UHR capability field 904a, 904b, 904c, or 904d, the serving or associated AP 404 may configure the optimal value based on factors such as the capability information 902, the RF tuning time, beacon or pilot measurement pilot transmission time of the AP 404, and any other historic or learning based optimal statistics.

In an embodiment, the UHR information 1004a or 1004b of either the association response message 1006a or the re-association response message 1006b respectively may include the T_{GM}_value 1002. Further, the UHR information 1004c or 1004d of either the multi-link setup response message 1006c or the link re-configuration response message 1006d respectively may include the updated T_{GM}_value.

In an embodiment, the T_{GM}_value may be configured as a single optimal value by the AP 404, or the T_{GM}_value may be configured per RF chain or frequency requirement of the STA device 402 or the non-AP MLD. If the perRF parameter is set to 0, then the T_{GM}_value may be the single optimal value applicable to all measurement needs of the STA device 402. Alternatively, if the perRF parameter is set to a non-zero value e.g., N, then an N number of the T_{GM}_value information may be configured corresponding to each RF chain or frequency as declared by the STA device in the UHR capability field 904a, 904a, 904b, 904c, or 904d.

In an embodiment, the T_{GM}_Value (single or perRF) may include associated parameters such as,
a) tech_freq: to which the RF chain or the frequency is applicable,
b) gap_offset: offset to apply before starting the T_{GM}_value time duration,
c) gap_length: length of the T_{GM}_value time duration,
d) gap_periodicity: periodicity of applying T_{GM}_value time duration,
e) event_trigger: any optional criteria configured by the AP 404, which when met dynamically, may trigger an instant T_{GM}_value gap for the one or more measurement operations. In an example, during the pre-emption event, when the STA device 402 is already in an active data session but the session gets suspended due to another low-latency traffic, the time gap may be used for the one or more measurement operations. Similarly, if the current AP RSSI as measured by STA device 402 falls below the predefined threshold, then the STA device 402 may apply the measurement gap for neighbor AP measurements and so on.
f) validity: The validity parameter may ensure that the one or more measurement operations performed within the minimum time gap are valid for how long until a new or fresh measurement is required for the same frequency or frequencies.

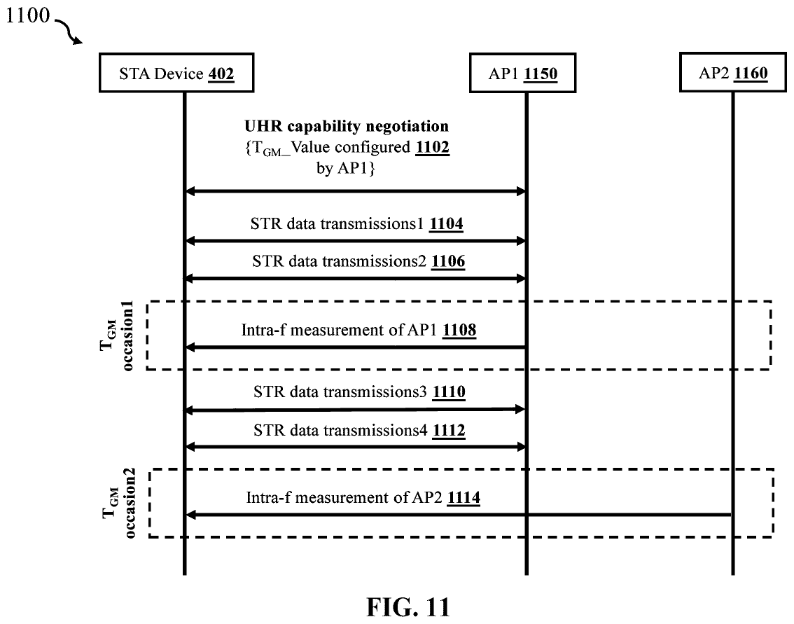

FIG. 11 is a signal flow diagram illustrating an example method 1100 for performing the one or more intra-frequency measurements, according to various embodiments. The signal flow diagram 1100 may include a sequence of operations performed between the STA device 402, an AP1 1150, and an AP2 1160. The AP1 1150 and the AP2 1160 may be intra-frequency neighbors and the STA device 402 may be associated with the AP1 1150. In an embodiment, the STA device 402 operates on a certain frequency in a Simultaneous Transmission and Reception (STR) mode. The STA device 402 may not be able to perform the one or more intra-frequency measurements during the STR traffic duration.

At 1102, the method 1100 may performing the UHR capability negotiation between the STA device 402 and the AP1 1150. For example, the method 1100 may include configuring the T_{GM} duration value by the AP1 1150 to aid the STA device 402 for performing the one or more intra-frequency measurements at known occasions.

In an embodiment, the T_{GM} duration value provided by the AP1 1150 overlaps with non-STR durations as per the below-mentioned options:
1) Creating short gaps during long TXOPs, using any significant inter-frame spacing (IFS) delays,
2) using channel back-offs during enhanced distributed channel access (EDCA)
3) uplink orthogonal-frequency-division-multiplexing random access (UORA) procedures, and
4) using suspended durations in the presence of pre-emptive low-latency traffic. The non-STR durations may include time intervals during which the STA device 402 or non-AP MLD is not engaged in simultaneous transmission and reception of data traffic on the same or different frequency resources.

At 1104 and 1106, the method 1100 may include performing, by the STA device 402, one or more simultaneous STR data transmission and reception of data with the AP1 1150.

At 1108, the method 1100 may include performing, by the STA device 402 for the AP1 1150, an intra-frequency measurement of the AP1 1150 at T_{GM} occassion1.

At 1110 and 1112, the method 1100 may include performing, by the STA device 402, one or more simultaneous STR data transmission and reception of the data with the AP1 1150.

At 1114, the method 1100 may include performing, by the STA device 402 for the AP2 1160, the intra-frequency measurement of the AP2 1160 at T_{GM} occassion2.

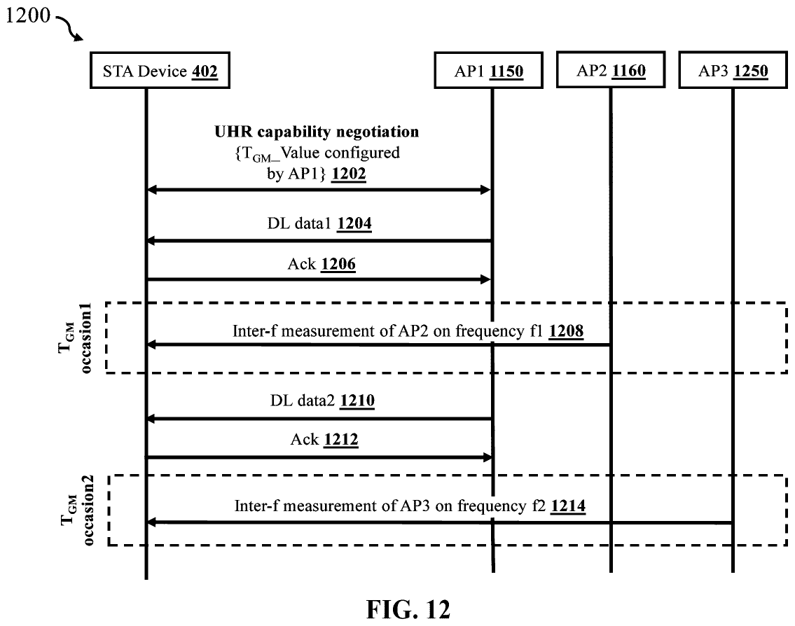

FIG. 12 is a signal flow diagram illustrating an example method 1200 for performing the one or more inter-frequency measurements, according to various embodiments. The signal flow diagram 1100 may include a sequence of operations performed between the STA device 402, the AP1 1150, the AP2 1160, and the AP3 1250.

The AP1 1150, the AP2 1160, and the AP3 1250 may be the inter-frequency neighbors, and the STA device 402 is associated with the AP1 1150. In an embodiment, the STA device 402 operates on a certain frequency. The STA device 402 may not be able to perform the one or more inter-frequency measurements of the AP2 1160 and AP3 1250 while being busy on a channel in the AP1 1150.

At 1202, the method 1200 may include performing the UHR capability negotiation between the STA device 402 and the AP1 1150. For example, the method 1200 may include configuring the T_{GM} duration value by the AP1 1150 to aid the STA device 402 for performing the one or more inter-frequency measurements at known occasions.

In an embodiment, the T_{GM} duration value provided by the AP1 1150 is configured (by the AP 404) to overlap with the below duration as below options:
1) Creating short gaps during long TXOPs,
2) using any significant inter-frame spacing (IFS) delays,
3) using channel back-offs during Enhanced Distributed Channel Access (EDCA) or uplink orthogonal-frequency-division-multiplexing random access (UORA) procedures,
4) using suspended durations in presence of pre-emptive low latency traffic.

At 1204, the method 1200 may include receiving, by the STA device 402 and from the AP1 1150, a first downlink data from the AP1 1150.

At 1206, the method 1200 may include transmitting, by the STA device 402, an acknowledgement of the first downlink data to the AP1 1150.

At 1208, the method 1200 may include performing, by the STA device 402, an inter-frequency measurement of the AP2 1160 on a frequency f1 at T_{GM} occassion1.

At 1210, the method 1200 may include receiving, by the STA device 402, a second downlink data from the AP1 1150.

At 1212, the method 1200 may include transmitting, by the STA device 402, an acknowledgement of the second downlink data to the AP1 1150.

At 1214, the method 1200 may include performing, by the STA device 402, the inter-frequency measurement of the AP3 1250 on a frequency f2 at T_{GM} occassion2.

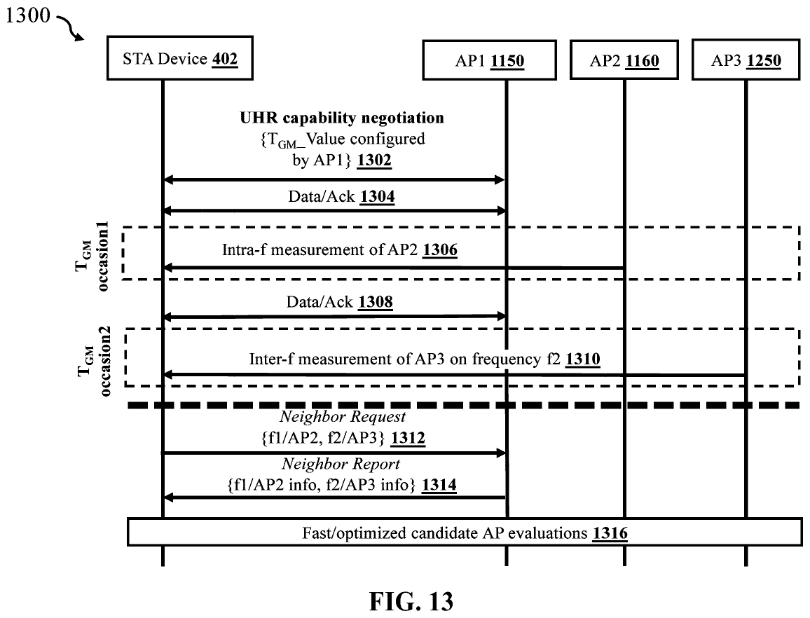

FIG. 13 is a signal flow diagram illustrating an example method 1300 for performing optimally, the one or more neighbor measurements at the STA device 402, according to various embodiments.

At 1302, the method 1300 may include performing the UHR capability negotiation between the STA device 402 and the AP1 1150. Particularly, the method 1300 may include configuring the T_{GM} duration value by the AP1 1150 to aid the STA device 402 in performing the one or more intra-frequency measurements and the one or more inter-frequency measurements.

In an embodiment, the STA device 402 is associated with AP1 1150, and T_{GM} occasions have been configured.

At 1304, the method 1300 may include transmitting, bi-directional data and acknowledgement between the STA device 402 and the AP1 1150.

At 1306, the method 1300 may include performing, by the STA device 402, the one or more intra-frequency measurements of the AP2 1160 at T_{GM} occasion1.

At 1308, the method 1300 may include transmitting, bi-directional data and acknowledgement between the STA device 402 and the AP1 1150.

At 1310, the method 1300 may include performing, by the STA device 402, the one or more inter-frequency measurements of the AP3 1250 on a frequency f2 at T_{GM} occassion2.

In an embodiment, the STA device 402 performs the one or more intra-frequency measurements and the one or more inter-frequency measurements on neighbor AP2 1160 and AP3 1250, respectively, in the configured T_{GM} occasions.

At 1312, the method 1300 may include transmitting, by the STA device 402, the neighbor report request message to the AP1 1150. The neighbor report request message comprises the one or more determined AP identifiers. The one or more determined AP identifiers may include frequency f1 or identifier of the AP2, the frequency f2 or identifier of the AP3.

In an embodiment, to get the list of one or more determined AP identifiers, the APs information for evaluation of potential target candidates, especially during mobility scenarios, is obtained using the neighbor report request message. The STA device 402 may explicitly include a subset of measured neighbor APIDs or frequencies.

At 1314, the method 1300 may include receiving the neighbor report message from the AP1 1150. The neighbor report message may include the information corresponding to the one or more AP identifiers.

In an embodiment, with the inclusion of the APIDs or frequencies in the neighbor report message, instead of including the information for all possible candidate neighbor APs, the AP1 1150 may include only the subset of the APs corresponding to the included ones by the STA device 402 in the neighbor report message to the STA device 402. Further, for receiving the optimized neighbor report message, the STA device 402 may consider a smaller and definite set of optimal neighbor APs to evaluate for mobility or roaming purposes.

At 1316, performing, by the STA device 402, optimized candidate AP evaluations based on the received neighbor report message.

If the standard feature radio measurement (e.g., e.g., dot11RMNeighborReportActivated) is valid, then the STA device 402 may utilize the one or more intra-frequency measurements and the one or more inter-frequency measurements acquired during the T_{GM} duration. A current neighbor request or report procedure may be much optimized for standards such as WiFi8 and beyond.

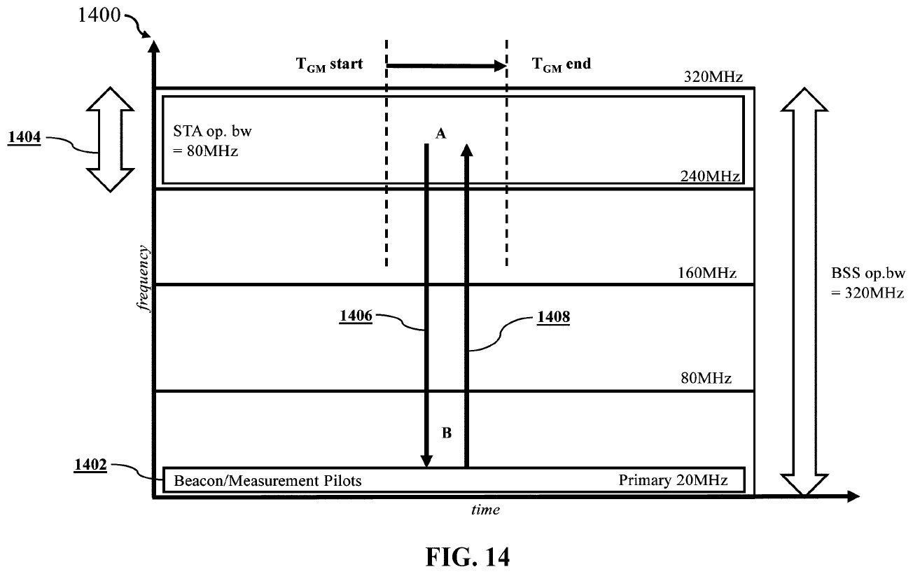

FIG. 14 is a diagram illustrating an example use case depicting a method 1400 for performing the one or more out-of-band beacons and the pilot measurements, according to various embodiments. As shown in FIG. 14, the STA device 402 may include an operating bandwidth of 80 MHz. In an embodiment, the AP 404 may be on 6 GHz spectrum with 320 MHz operating bandwidth.

At 1402, the method 1400 may include detecting, by the STA device 1402, the beacon of the AP 404 at a primary channel, followed by association and other configurations. The primary channel includes a 20 Mega Hertz (MHz) channel. Further, other configurations may include the T_{GM}_value.

At 1404, the method 1400 may include operating, by the STA device 402, in a top 80 MHz portion of the AP's spectrum based on a Dynamic Sub-band Operation (DSO) or Non-Primary Channel Access (NPCA) procedure configured by the AP 404.

At 1406, the method 1400 may include initiating, by the STA device 402, the time gap for measurement occasion while operating in a top 80 MHz portion, and tuning the RF chain from a first point (e.g., point A) towards a second point (e.g., point B) to reach a bottom primary 20 MHz channel to perform the one or more Beacon or pilot measurements.

At 1408, the method 1400 may include completing, by the STA device 402, the measurement on the bottom primary 20 MHz channel and tuning the RF chain back from the second point (point B) to the first point (point A) to return to the top allocated channel before the time gap for measurement occasion ends, and resuming normal data traffic operations.

In an embodiment, to avoid beacon duplication across all 20 MHz bands in the AP's operating bandwidth, the system 406 may instead make efficient use of the time gap for the one or more measurement operations. During the T_{GM} occasions, the STA device 402 may acquire measurements of the AP 404 by tuning the RF chain. The STA device 402 may gather the required beacon or pilot information without the need for redundant beacon transmissions by the AP.

In effect, this conserves valuable spectrum resources, which otherwise would have been consumed by duplicate beacon transmissions and also reduces power consumption at the AP 404 by eliminating unnecessary beacon duplication as well as AP power saving (no more duplicate Beacon transmissions).

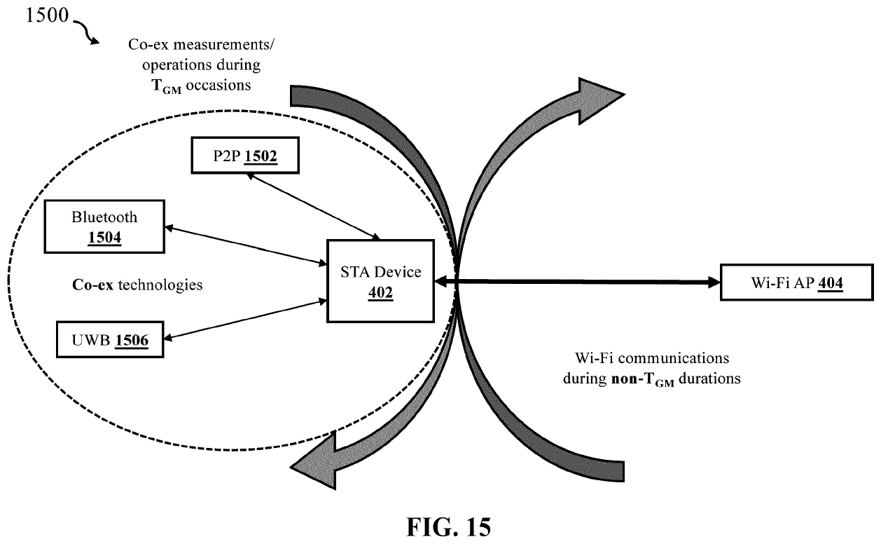

FIG. 15 is a diagram illustrating examples of the one or more cross-technology measurements performed by the STA device 402, according to various embodiments.

As shown in FIG. 15, the one or more cross-technologies may include a Peer-to-Peer (P2P) wireless communication network 1502, a Bluetooth network 1504, an ultra-wideband (UWB) network 1506, and the like.

In an embodiment, the STA device 402 may be required to participate in the one or more cross-technology measurements in parallel to operating in Wi-Fi communication with AP 404. Accordingly, if the STA device 402 declares need and support for the T_{GM} for co-existence technology in the UHR capability, then the time gap for measurement T_{GM} Value may also be configured for the one or more cross-technology measurements of the STA device 402.

In an embodiment, the STA device 402 may continue with regular Wi-Fi operations in association with the AP 404 during the non-T_{GM} durations. In an embodiment, the STA device 402 may be configured to use the configured T_{GM} occasions for the one or more cross-technology measurements. In an embodiment, the T_{GM} duration value provided by the AP 404 may be configured to overlap with the below duration as per following options:
1) Creating short gaps during long TXOPs,
2) using any significant inter-frame spacing (IFS) delays,
3) using channel back-offs during enhanced distributed channel access (EDCA) or uplink orthogonal-frequency-division-multiplexing random access (UORA) procedures,
4) using the actual unavailability durations, if any, as declared by the STA device 402 for co-ex use cases, and
5) using suspended durations in the presence of pre-emptive low-latency traffic.

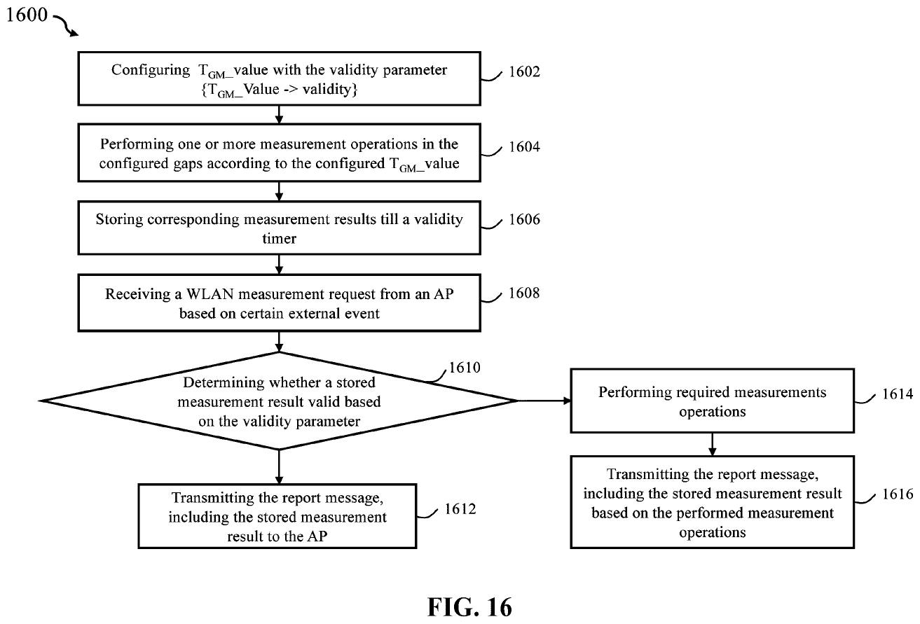

FIG. 16 is a flowchart illustrating an example method 1600 for transmitting the report message based on the one or more measurement operations to the AP 404, according to various embodiments.

At 1602, the method 1600 may include configuring, by the AP 402, the T_{GM}_value with the validity parameter (T_{GM}_Value->validity).

At 1604, the method 1600 may include performing, by the STA device 402, the one or more measurement operations in configured gaps according to the configured T_{GM}_value.

At 1606, the method 1600 may include storing, by the STA device 402, corresponding measurement results in a memory associated with the STA device 402 till a validity timer.

At 1608, the method 1600 may include receiving a WLAN measurement request from the AP 404 based on a certain external event.

At 1610, the method 1600 may include determining, by the STA device 402, whether a stored measurement result corresponding to the requested frequency remains valid based on the validity parameter.

At 1612, the method 1600 may include transmitting, by the STA device 402, the report message, including the stored measurement result, to the AP 404 in response to determining that the measurement result remains valid.

At 1614, the method 1600 may include performing the required measurement operations first in response to determining that the measurement result remains invalid.

At 1616, transmitting, by the STA device 402, the report message, including the stored measurement result based on the performed measurement operations.

Thus, the request or report procedure may be optimized and fastened with reduced processing time at an event occurrence.

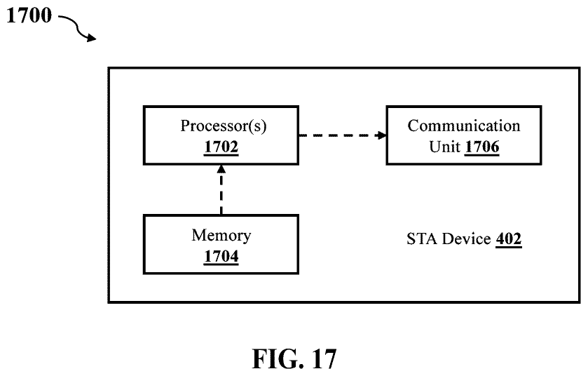

FIG. 17 is a block diagram 1700 illustrating an example configuration of the STA device 402, according to various embodiments. The STA device 402 may include one or more processors (e.g., including processing circuitry) 1702 (also referred to as the “processor” 1702), a memory unit (e.g., including a memory) 1704 (also referred to as the “memory” 1704), and a communication unit (e.g., including communication circuitry) 1706 (e.g., communicator or communication interface).

In an embodiment, the processor 1702 may include various processing circuitry and may include a single processing unit or a number of units, all of which could include multiple computing units. The processor 1702 may be implemented as one or more microprocessors, microcomputers, microcontrollers, digital signal processors, central processing units, state machines, logic circuitries, and/or any devices that manipulate signals based on operational instructions. Among other capabilities, the processor 1702 is configured to fetch and execute computer-readable instructions and data stored in the memory unit 1704 to perform operations/functions associated with the STA device 402, as discussed throughout the present disclosure. The processor 1702 may include one or a plurality of processors. At this time, one or a plurality of processors 1702 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 1702 may control the processing of the input data in accordance with a predefined operating rule or artificial intelligence (AI) model stored in the non-volatile memory and the volatile memory, e.g., memory unit 1704. The predefined operating rule or artificial intelligence model is provided through training or learning. Thus, the processor 1702 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the memory unit 1704 may include any non-transitory computer-readable medium known in the art including, for example, volatile memory, such as static random-access memory (SRAM) and dynamic random access memory (DRAM), and/or non-volatile memory, such as read-only memory (ROM), erasable programmable ROM, flash memories, hard disks, optical disks, and magnetic tapes. The memory 1704 stores instructions that, when executed by at least one processor individually or collectively, cause the STA device 402 to perform the methods and/or the operations described herein. The at least one processor may include the combination of one or more processors such as the processor(s) 1702, the processing circuitry in the communication unit 1706, a CPU, GPU, MPU, an application processor (AP), and a communication processor (CP). The communication unit 1706 may be controlled by the processor(s) 1702.

In an embodiment, the communication unit 1706 may include various communication circuitry and be configured to perform one or more functions for transmitting and receiving signals via a wireless channel.

FIG. 18 is a block diagram 1800 illustrating an example configuration of the AP 404, according to various embodiments. The network entity 304 may include one or more processors (e.g., including processing circuitry) 1802 (also referred to as the “processor” 1802), a memory unit (e.g., including a memory) 1804 (also referred to as the “memory” 1804), and a communication unit (e.g., including communication circuitry) 1806 (e.g., communicator or communication interface). The processor 1802, the memory unit 1804, and the communication unit 1806 may be similar to the processor 1702, the memory unit 1704, and the communication unit 1706 of FIG. 17. Therefore, the description of the processor 1802, the memory unit 1804, and the communication unit 1806 may not be repeated with reference to FIG. 18 for the sake of brevity.

One aspect of the present disclosure provides a station (STA) for wireless communication. The STA comprises at least one processor including processing circuitry. The STA comprises memory storing instructions that, when executed by the at least one processor individually or collectively, cause the STA to transmit, to an Access Point (AP), capability information indicating one or more parameters associated with Time Gap for Measurement (T_{GM}) supported by the STA. The instructions, when executed by the at least one processor individually or collectively, cause the STA to receive, from the AP, a time gap configuration. The instructions, when executed by the at least one processor individually or collectively, cause the STA to perform one or more measurement operations based on the time gap configuration. The one or more measurement operations comprise at least one of one or more intra-frequency measurements, one or more inter-frequency measurements, one or more out-of-band beacon and pilot measurements, and one or more cross-technology measurements.

In an embodiment, the capability information comprises a T_{GM} support bit indicating a support for the time gap configuration, a technology parameter indicating support for different types of technologies, one or more timing parameters per radio frequency (RF) band associated with each of the supported technologies indicating at least a minimum time gap required for measuring each of the corresponding supported technology.

In an embodiment, the transmitting of the capability information comprises transmitting the capability information in one of an association request, a re-association request, a multi-link setup request, or a link reconfiguration request message.

In an embodiment, the time gap configuration comprises a gap offset, a gap length, a gap periodicity, an event trigger, and a validity parameter.

In an embodiment, the instructions, when executed by the at least one processor individually or collectively, cause the STA to perform, based on the received time gap configuration, at least one or more of intra-frequency measurements and inter-frequency measurements on one or more neighboring APs.

In an embodiment, the instructions, when executed by the at least one processor individually or collectively, cause the STA to perform, based on the received time gap configuration, the one or more cross-technology measurements associated with one or more co-existence technology operations, by tuning the radio frequency of the STA during a time gap defined by the time gap configuration.

In an embodiment, in response to receiving a wireless local area network (WLAN) measurement request from the AP, the instructions, when executed by the at least one processor individually or collectively, cause the STA to determine whether a corresponding measurement result is already stored and remains valid based on a validity parameter associated with the time gap configuration corresponding to the WLAN measurement request. In response to determining that the stored corresponding measurement result is valid, the instructions, when executed by the at least one processor individually or collectively, cause the STA to transmit a report message including the stored corresponding measurement result to the AP.

One aspect of the present disclosure provides a station (STA) for wireless communication. The STA comprises at least one processor including processing circuitry. The STA comprises memory storing instructions that, when executed by the at least one processor individually or collectively, cause the STA to perform one or more measurement operations based on a received tap gap configuration. The one or more measurement operations comprise at least one of one or more intra-frequency measurements, one or more inter-frequency measurements, one or more out-of-band beacon and pilot measurements, and one or more cross-technology measurements. Upon performing the one or more measurement operations, the instructions, when executed by the at least one processor individually or collectively, cause the STA to detect neighbor Access Points (APs) or one or more frequencies. The instructions, when executed by the at least one processor individually or collectively, cause the STA to determine one or more identifiers of the detected neighbor Access Points (APs) or the one or more frequencies based on a Received Signal Strength Indicator (RSSI) exceeding a predefined specified threshold. The instructions, when executed by the at least one processor individually or collectively, cause the STA to transmit a neighbor report request message to the AP. The neighbor report request message comprises the one or more AP identifiers. The instructions, when executed by the at least one processor individually or collectively, cause the STA to receive a neighbor report message from the AP, wherein the neighbor report message comprises information corresponding to the one or more AP identifiers. The instructions, when executed by the at least one processor individually or collectively, cause the STA to perform the one or more neighbor measurements and evaluation based on the received neighbor report message.

One aspect of the present disclosure provides an access point (AP) for wireless communication. The AP comprises at least one processor including processing circuitry. The AP comprises memory storing instructions that, when executed by the at least one processor individually or collectively, cause the AP to receive capability information from a station (STA). The capability information indicating one or more parameters associated with Time Gap for Measurement (T_{GM}) supported by the STA. The instructions, when executed by the at least one processor individually or collectively, cause the AP to determine a time gap configuration for the STA, based on at least one of the capability information of the STA, radio frequency tuning information associated with the STA, or transmission scheduling information. The instructions, when executed by the at least one processor individually or collectively, cause the AP to transmit the time gap configuration to the associated STA.

In an embodiment, the capability information comprises a T_{GM} support bit indicating a support for the time gap configuration, a technology parameter indicating support for different types of technologies, one or more timing parameters per radio frequency (RF) band associated with each of the supported technologies indicating at least a minimum time gap required for measuring each of the corresponding supported technology.

In an embodiment, the determining of the time gap configuration comprises determining the time gap configuration by configuring at least one of a single optimal value applicable across a plurality of frequencies, a plurality of values per a radio frequency chain, or a frequency band based on a frequency-specific measurement configuration indicator.

In an embodiment, wherein the instructions, when executed by the at least one processor individually or collectively, cause the AP to transmit the time gap configuration in one of an association response message, a re-association response message, a multi-link setup response message, or a link re-configuration response message.

In an embodiment, the time gap configuration comprises a plurality of measurement configuration parameters corresponding to a plurality of radio frequency chains.

In an embodiment, the instructions, when executed by the at least one processor individually or collectively, cause the AP to determine a duration parameter associated with the time gap configuration based on one or more of: a transmission opportunity (TXOP) interruption duration, an inter frame spacing interval, an Enhanced Distributed Channel Access (EDCA) backoff duration, or an Uplink Orthogonal-Frequency-Division-Multiplexing Random Access (U-OFDMA) backoff duration.

In an embodiment, the time gap configuration comprises an event trigger indicating a condition under which the STA is to perform the one or more measurement operations.

One aspect of the present disclosure provides method for wireless communication performed by a station (STA). The method comprises transmitting, to an Access Point (AP), capability information indicating one or more parameters associated with Time Gap for Measurement (T_{GM}) supported by the STA. The method comprises receiving, from the AP, a time gap configuration in response to the transmitted capability information. The method comprises performing the one or more measurement operations based on the received time gap configuration, wherein the one or more measurement operations comprise at least one of one or more intra-frequency measurements, one or more inter-frequency measurements, one or more out-of-band beacon and pilot measurements, and one or more cross-technology measurements.

In an embodiment, the capability information comprises a T_{GM} support bit indicating a support for the time gap configuration, a technology parameter indicating support for different types of technologies, one or more timing parameters per radio frequency (RF) band associated with each of the different type of technologies indicating at least a minimum time gap required for measuring each of the corresponding supported technology.

In an embodiment, the transmitting of the capability information comprises transmitting the capability information in one of an association request, a re-association request, a multi-link setup request, or a link reconfiguration request message.

In an embodiment, the time gap configuration comprises a gap offset, a gap length, a gap periodicity, an event trigger, and a validity parameter.

In an embodiment, the method comprises performing, based on the received time gap configuration, at least one or more of intra-frequency measurements and inter-frequency measurements on one or more of neighboring APs.

In an embodiment, the method comprises performing, based on the received time gap configuration, the one or more cross-technology measurements associated with one or more co-existence technology operations, by tuning the radio frequency of the STA during a time gap defined by the time gap configuration.

In an embodiment, the method comprises: in response to receiving a wireless local area network (WLAN) measurement request from the AP, determining, whether a corresponding measurement result is already stored and remains valid based on a validity parameter associated with the time gap configuration corresponding to the WLAN measurement request. The method comprises: in response to determining that the stored corresponding measurement result is valid, transmitting, a report message including the stored corresponding measurement result to the AP.

One aspect of the present disclosure provides method for wireless communication performed by a station (STA). The method comprises performing one or more measurement operations based on a received time gap configuration. The one or more measurement operations comprise at least one of one or more intra-frequency measurements, one or more inter-frequency measurements, one or more out-of-band beacon and pilot measurements, and one or more cross-technology measurements. The method comprises detecting neighbor Access Points (APs) or one or more frequencies upon performing the one or more measurement operations. The method comprises determining one or more AP identifiers for one or more detected neighbor Access Points (APs) or the one or more frequencies based on a Received Signal Strength Indicator (RSSI) exceeding a specified threshold. The method comprises transmitting a neighbor report request message to the AP, wherein the neighbor report request message comprises the one or more determined AP identifiers. The method comprises receiving a neighbor report message from the AP, wherein the neighbor report message comprises information corresponding to the one or more AP identifiers. The method comprises performing the one or more neighbor measurements and evaluation based on the received neighbor report message.

One aspect of the present disclosure provides method for wireless communication performed by an access point (AP). The method comprises receiving capability information from a station (STA), wherein the capability information indicating one or more parameters associated with Time Gap for Measurement (T_{GM}) supported by the STA. The method comprises determining the time gap configuration for the STA, based on at least one of the capability information of the STA, radio frequency tuning information associated with the STA, or transmission scheduling information. The method comprises transmitting the time gap configuration to the associated STA.

In an embodiment, the capability information comprises a T_{GM} support bit indicating a support for the time gap configuration, a technology parameter indicating support for different types of technologies, one or more timing parameters per radio frequency (RF) band associated with each of the supported technologies indicating at least a minimum time gap required for measuring each of the corresponding supported technology.

In an embodiment, the determining of the time gap configuration comprises determining the time gap configuration by configuring at least one of a single optimal value applicable across a plurality of frequencies, a plurality of values per a radio frequency chain, or a frequency band based on a frequency-specific measurement configuration indicator.

In an embodiment, the determining of the time gap configuration comprises transmitting the time gap configuration in one of an association response message, a re-association response message, a multi-link setup response message, or a link re-configuration response message.

In an embodiment, the time gap configuration comprises a plurality of measurement configuration parameters corresponding to a plurality of radio frequency chains.

In an embodiment, the method comprises determining a duration parameter associated with the time gap configuration based on one or more of: a transmission opportunity (TXOP) interruption duration, an inter frame spacing interval, an Enhanced Distributed Channel Access (EDCA) backoff duration, or an Uplink Orthogonal-Frequency-Division-Multiplexing Random Access (U-OFDMA) backoff duration.

In an embodiment, the time gap configuration comprises an event trigger indicating a condition under which the STA is to perform the one or more measurement operations.

An aspect of the present disclosure provides a non-transitory computer-readable storage medium. The methods disclosed herein can be performed by one or more computer programs stored on the non-transitory computer-readable storage.

An aspect of the present disclosure provides a non-statutory computer-readable storage medium storing one or more computer programs comprising instructions to perform a method for wireless communication performed by a station (STA). The method comprises performing one or more measurement operations based on a received time gap configuration. The one or more measurement operations comprise at least one of one or more intra-frequency measurements, one or more inter-frequency measurements, one or more out-of-band beacon and pilot measurements, and one or more cross-technology measurements. The method comprises detecting neighbor Access Points (APs) or one or more frequencies upon performing the one or more measurement operations. The method comprises determining one or more AP identifiers for one or more detected neighbor Access Points (APs) or the one or more frequencies based on a Received Signal Strength Indicator (RSSI) exceeding a specified threshold. The method comprises transmitting a neighbor report request message to the AP, wherein the neighbor report request message comprises the one or more determined AP identifiers. The method comprises receiving a neighbor report message from the AP, wherein the neighbor report message comprises information corresponding to the one or more AP identifiers. The method comprises performing the one or more neighbor measurements and evaluation based on the received neighbor report message.

An aspect of the present disclosure provides a non-statutory computer-readable storage medium storing one or more computer programs comprising instructions to perform a method for wireless communication performed by an access point (AP). The method comprises receiving capability information from a station (STA), wherein the capability information indicating one or more parameters associated with Time Gap for Measurement (T_{GM}) supported by the STA. The method comprises determining the time gap configuration for the STA, based on at least one of the capability information of the STA, radio frequency tuning information associated with the STA, or transmission scheduling information. The method comprises transmitting the time gap configuration to the associated STA.

The present disclosure provides various advantages. The present disclosure provides a standards-based long-term AP-assisted WLAN measurement framework. Further, the present disclosure provides comparable chipset performance based on standard compliance. The present disclosure also provides efficient and timely intra-frequency, inter-frequency, out-of-bandwidth, or co-ex measurements.

The present disclosure provides an enhanced neighbor request or report procedure. Additionally, the present disclosure provides enhanced generic request or response-based WLAN measurement procedures.

While specific language has been used to describe the present disclosure, any limitations arising on account thereto, are not intended. As would be apparent to a person in the art, various working modifications may be made to the method in order to implement the teachings of the disclosure as taught herein. The drawings and the foregoing description give examples of various embodiments. Those skilled in the art will appreciate that one or more of the described elements may well be combined into a single functional element. Certain elements may be split into multiple functional elements. Elements from one embodiment may be added to another embodiment.

What is claimed is:

1. A station (STA) for wireless communication, the STA comprising:
at least one processor including processing circuitry; and
memory storing instructions that, when executed by the at least one processor individually or collectively, cause the STA to:
transmit, to an Access Point (AP), capability information indicating one or more parameters associated with Time Gap for Measurement (T_{GM}) supported by the STA;
receive, from the AP, a time gap configuration; and
perform one or more measurement operations based on the time gap configuration, wherein the one or more measurement operations comprise at least one of one or more intra-frequency measurements, one or more inter-frequency measurements, one or more out-of-band beacon and pilot measurements, and one or more cross-technology measurements.

2. The STA of claim 1, wherein the capability information comprises a T_{GM} support bit indicating a support for the time gap configuration, a technology parameter indicating support for different types of technologies, one or more timing parameters per radio frequency (RF) band associated with each of the supported technologies indicating at least a minimum time gap required for measuring each of the corresponding supported technology.

3. The STA of claim 1, wherein the transmitting of the capability information comprises:
transmitting the capability information in one of an association request, a re-association request, a multi-link setup request, or a link reconfiguration request message.

4. The STA of claim 1, wherein the time gap configuration comprises a gap offset, a gap length, a gap periodicity, an event trigger, and a validity parameter.

5. The STA of claim 1, wherein the instructions, when executed by the at least one processor individually or collectively, cause the STA to:
perform, based on the received time gap configuration, at least one or more of intra-frequency measurements and inter-frequency measurements on one or more neighboring APs

6. The STA of claim 1, wherein the instructions, when executed by the at least one processor individually or collectively, cause the STA to:
perform, based on the received time gap configuration, the one or more cross-technology measurements associated with one or more co-existence technology operations, by tuning the radio frequency of the STA during a time gap defined by the time gap configuration.

7. The STA of claim 1, in response to receiving a wireless local area network (WLAN) measurement request from the AP, wherein the instructions, when executed by the at least one processor individually or collectively, cause the STA to:
determine whether a corresponding measurement result is already stored and remains valid based on a validity parameter associated with the time gap configuration corresponding to the WLAN measurement request; and
in response to determining that the stored corresponding measurement result is valid, transmit a report message including the stored corresponding measurement result to the AP.

8. An access point (AP) for wireless communication, the AP comprising:
at least one processor including processing circuitry; and
memory storing instructions that, when executed by the at least one processor individually or collectively, cause the AP to:
receive capability information from a station (STA), wherein the capability information indicating one or more parameters associated with Time Gap for Measurement (T_{GM}) supported by the STA;
determine a time gap configuration for the STA, based on at least one of the capability information of the STA, radio frequency tuning information associated with the STA, or transmission scheduling information; and
transmit the time gap configuration to the associated STA.

9. The AP of claim 8, wherein the capability information comprises a T_{GM} support bit indicating a support for the time gap configuration, a technology parameter indicating support for different types of technologies, one or more timing parameters per radio frequency (RF) band associated with each of the supported technologies indicating at least a minimum time gap required for measuring each of the corresponding supported technology.

10. The AP of claim 8, wherein the determining of the time gap configuration comprises:
determining the time gap configuration by configuring at least one of a single optimal value applicable across a plurality of frequencies, a plurality of values per a radio frequency chain, or a frequency band based on a frequency-specific measurement configuration indicator.

11. The AP of claim 8, wherein the instructions, when executed by the at least one processor individually or collectively, cause the AP to:
transmit the time gap configuration in one of an association response message, a re-association response message, a multi-link setup response message, or a link re-configuration response message.

12. The AP of claim 8, wherein the time gap configuration comprises a plurality of measurement configuration parameters corresponding to a plurality of radio frequency chains.

13. The AP of claim 8, wherein the instructions, when executed by the at least one processor individually or collectively, cause the AP to:
determine a duration parameter associated with the time gap configuration based on one or more of: a transmission opportunity (TXOP) interruption duration, an inter frame spacing interval, an Enhanced Distributed Channel Access (EDCA) backoff duration, or an Uplink Orthogonal-Frequency-Division-Multiplexing Random Access (U-OFDMA) backoff duration.

14. The AP of claim 8, wherein the time gap configuration comprises an event trigger indicating a condition under which the STA is to perform the one or more measurement operations.

15. A method for wireless communication performed by a station (STA), the method comprising:
transmitting, to an Access Point (AP), capability information indicating one or more parameters associated with Time Gap for Measurement (T_{GM}) supported by the STA;
receiving, from the AP, a time gap configuration in response to the transmitted capability information; and
performing the one or more measurement operations based on the received time gap configuration, wherein the one or more measurement operations comprise at least one of one or more intra-frequency measurements, one or more inter-frequency measurements, one or more out-of-band beacon and pilot measurements, and one or more cross-technology measurements.

16. The method of claim 15, wherein the capability information comprises a T_{GM} support bit indicating a support for the time gap configuration, a technology parameter indicating support for different types of technologies, one or more timing parameters per radio frequency (RF) band associated with each of the different type of technologies indicating at least a minimum time gap required for measuring each of the corresponding supported technology.

17. The method of claim 15, wherein the transmitting of the capability information comprises:
transmitting the capability information in one of an association request, a re-association request, a multi-link setup request, or a link reconfiguration request message.

18. The method of claim 15, wherein the time gap configuration comprises a gap offset, a gap length, a gap periodicity, an event trigger, and a validity parameter.

19. The method of claim 15, further comprising:
performing, based on the received time gap configuration, at least one or more of intra-frequency measurements and inter-frequency measurements on one or more of neighboring APs.

20. The method of claim 15, further comprising:
performing, based on the received time gap configuration, the one or more cross-technology measurements associated with one or more co-existence technology operations, by tuning the radio frequency of the STA during a time gap defined by the time gap configuration.
